(19) United States
(12) Patent Application Publication
(10) Pub. No.: US 2026/0062566 A1
(43) Pub. Date: Mar. 5, 2026

(54) PLASTICIZER COMPOSITION CONTAINING TRIMETHYL ESTERS OF CYCLOHEXANE-1,2,4-TRIPROPIONIC ACID AND A TRIALKYL TRIMELLITATE

(71) Applicant: Evonik Oxeno GmbH & Co. KG, Marl (DE)

(72) Inventors: Michael Grass, Haltern am See (DE); Monika Rusek, Essen (DE); Michael van Eickels, Recklinghausen (DE)

(73) Assignee: Evonik Oxeno GmbH & Co. KG, Marl (DE)

(21) Appl. No.: 19/316,113

(22) Filed: Sep. 2, 2025

(30) Foreign Application Priority Data
Sep. 3, 2024 (EP) 24198042.4

(51) Int. Cl. C09D 7/63; C08K 5/12; C08K 5/1515; C09D 127/06

(52) U.S. Cl. CPC C09D 7/63; C09D 127/06; C08K 5/12; C08K 5/1515; C08K 2201/014

(57) ABSTRACT

A plasticizer composition contains a compound of the formula (1)

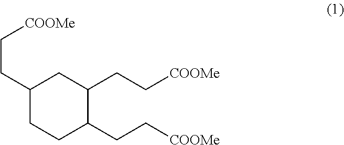 [SMILES: COC(=O)CCC1CCC(CCC(=O)OC)C(CCC(=O)OC)C1]

and at least one trialkyl trimellitate, where the three alkyl groups in the trialkyl trimellitate each have 8 or 9 carbon atoms.

### CROSS-REFERENCE TO RELATED APPLICATIONS

This patent application claims priority to European Patent Application No. 24198042.4, filed on Sep. 3, 2024, in the European Patent Office, the entire disclosure of which is hereby incorporated by reference herein.

### BACKGROUND OF THE INVENTION

### Field of the Invention

The invention provides a plasticizer composition comprising a compound of formula (1)

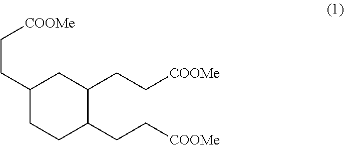 [SMILES: COC(=O)CCC1CCC(CCC(=O)OC)C(CCC(=O)OC)C1]

and at least one trialkyl trimellitate, where the three alkyl groups in the trialkyl trimellitate each have 4 to 10 carbon atoms, preferably 4 to 9 carbon atoms, further preferably 4, 5, 8 or 9 carbon atoms, more preferably 8 or 9 carbon atoms.

### Description of Related Art

The inventive compounds of formula (1) are trimethyl esters of cyclohexane-1,2,4-tripropionic acid. Trimethyl esters of cyclohexane-1,2,4-tripropionic acid are known in principle and have been described, for example, in EP 3 838 886 A1. It was also mentioned therein that these esters of cyclohexane-1,2,4-tripropionic acid can be used as plasticizers. The trimethyl ester has been described in this context as being a product having low gelation temperature.

These esters do not always show solely positive properties when used as plasticizers in plastics. For instance, if the trimethyl ester were to be used as the sole plasticizer, for example in a PVC-based plastisol formulation, the plastisol would have quite a high viscosity. In addition, when the plastisol is processed, a not inconsiderable proportion of the trimethyl ester would evaporate and hence no longer remain in the end product.

### SUMMARY OF THE INVENTION

It was thus an object of the present invention to provide a plasticizer composition containing the trimethyl ester of cyclohexane-1,2,4-tripropionic acid, but having better performance properties.

The invention includes but is not limited to the following embodiments:

1. A plasticizer composition, comprising:
a compound of the formula (1),

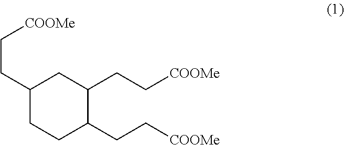 [SMILES: COC(=O)CCC1CCC(CCC(=O)OC)C(CCC(=O)OC)C1]

and
at least one trialkyl trimellitate, where the three alkyl groups each have 4 to 10 carbon atoms.

2. The plasticizer composition according to Embodiment 1, wherein the three alkyl groups are each independently selected from the group consisting of an n-butyl group, an isobutyl group, an n-pentyl group, a 2-methylbutyl group, a 3-methylbutyl group, an n-hexyl group, an isohexyl group, an n-octyl group, a 2-ethylhexyl group, an n-nonyl group, an isononyl group, an n-decyl group, an isodecyl group, and a 2-propylheptyl group.

3. The plasticizer composition according to Embodiment 1, wherein the three alkyl groups have a same number of carbon atoms.

4. The plasticizer composition according to Embodiment 1, wherein the trialkyl trimellitate is tri-n-butyl trimellitate (TBTM), triisopentyl trimellitate (TIPTM), tri-n-pentyl trimellitate (TPTM), tri-2-ethylhexyl trimellitate (TEHTM), triisononyl trimellitate (TINTM) or tri-(n-C8/n-C10) trimellitate (T810TM).

5. The plasticizer composition according to Embodiment 1, wherein the compound of formula (1) and the trialkyl trimellitate are present in the plasticizer composition in a weight ratio (compound of formula (1):trialkyl trimellitate) of 1:99 to 99:1.

6. The plasticizer composition according to Embodiment 1, wherein the plasticizer composition additionally comprises an epoxidized oil or an epoxidized alkyl ester of a fatty acid.

7. The plasticizer composition according to Embodiment 6, wherein the epoxidized oil is selected from the group consisting of epoxidized soybean oil, epoxidized castor oil, epoxidized linseed oil, epoxidized palm oil, epoxidized stearate, epoxidized oleate, epoxidized tall oil, epoxidized linoleate and mixtures thereof.

8. The plasticizer composition according to Embodiment 7, wherein the epoxidized oil is epoxidized soybean oil or epoxidized linseed oil.

9. The plasticizer composition according to Embodiment 6, wherein the epoxidized oil is present in the plasticizer composition in an amount of 1 to 150 parts by weight based on 100 parts by weight of a sum total of the compound of formula (1) and the trialkyl trimellitate.

10. The plasticizer composition according to Embodiment 1, wherein the composition additionally comprises at least one further plasticizer selected from the group consisting of adipates, benzoates, chlorinated hydrocarbons (called chloroparaffins), citrates, cyclohexanedicarboxylates, epoxidized fatty acid esters, epoxidized vegetable oils, epoxidized acylated glycerides, furandicarboxylates, isophthalates, phosphates, succinates, sulfonamides, sulfonates, terephthalates, trimellitates and oligomeric or polymeric esters based on adipic acid, succinic acid or sebacic acid are selected.

11. A plastic composition, comprising:
the plasticizer composition according to claim 1, and
a plastic.

12. The plastic composition according to Embodiment 11, wherein a proportion of the plasticizer composition is 5 to 150 parts by weight per 100 parts by weight of plastic.

13. The plastic composition according to Embodiment 11, wherein the plastic is selected from the group consisting of polyvinylchloride (PVC), polyalkylmethacrylate (PAMA), polyvinylbutyral (PVB), polyurethane, polysulfides, polylactic acid (PLA), polyhydroxybutyral (PHB), nitrocellulose and copolymers of vinyl chloride with vinyl acetate or with butyl acrylate.

14. The plastic composition according to Embodiment 13, wherein the plastic is polyvinylchloride (PVC).

15. A product, comprising:
the plastic composition according to Embodiment 11,
wherein the product is selected from the group consisting of adhesives, sealing compounds, coating compounds, varnishes, paints, plastisols, foams, imitation leathers, floor coverings, roofing membranes, underbody protection, fabric coatings, cables, wire insulation, hoses, extruded articles, films, automotive interior components, wallpaper, inks, toys, contact sheets, food packaging, and medical articles.

### DETAILED DESCRIPTION OF THE INVENTION

This object is achieved by the plasticizer composition according to Embodiment 1. The invention accordingly relates to a plasticizer composition containing a compound of formula (1)

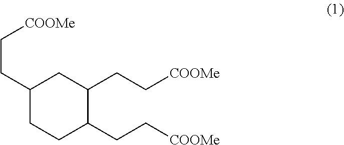 [SMILES: COC(=O)CCC1CCC(CCC(=O)OC)C(CCC(=O)OC)C1]

and at least one trialkyl trimellitate, where the three alkyl groups each have 4 to 10 carbon atoms, preferably 4 to 9 carbon atoms, further preferably 4, 5, 8 or 9 carbon atoms, more preferably 8 or 9 carbon atoms. Preferred embodiments of the present invention are specified in the subsidiary embodiments.

The trimethyl ester of cyclohexane-1,2,4-tripropionic acid, i.e. the substance which is part of the plasticizer composition according to the invention, is currently not commercially available. However, a process for preparing these esters is described, for example, in EP 3 842 411 A1. The esters of cyclohexane-1,2,4-tripropionic acid are thus generally obtainable.

In addition to the trimethyl esters of cyclohexane-1,2,4-tripropionic acid, the plasticizer composition according to the invention contains trialkyl trimellitates, where the three alkyl groups each independently have 4 to 10 carbon atoms, preferably 4 to 9 carbon atoms, further preferably 4, 5, 8 or 9 carbon atoms, more preferably 8 or 9 carbon atoms. The corresponding compounds can be described by the following Markush formula:

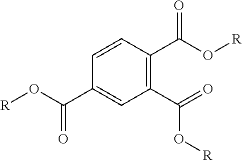

where the three R radicals are each independently alkyl groups having 4 to 10 carbon atoms, preferably 4 to 9 carbon atoms, further preferably 4, 5, 8 or 9 carbon atoms, more preferably 8 or 9 carbon atoms.

The three alkyl groups may each be independently selected from the group consisting of an n-butyl group, an isobutyl group, an n-pentyl group, a 2-methylbutyl group, a 3-methylbutyl group, an n-hexyl group, an isohexyl group, an n-octyl group, a 2-ethylhexyl group, an n-nonyl group, an isononyl group, an n-decyl group, an isodecyl group, a 2-propylheptyl group. For the purposes of the present invention, an isononyl group means a mixture of linear and branched C9 alcohols.

The three alkyl groups of trialkyl trimellitate may be the same or different. The present invention thus also encompasses mixed esters in which the alkyl groups have different chain lengths. In a preferred embodiment of the present invention, the three alkyl groups of the trialkyl trimellitate each have the same number of carbon atoms. This means that the alkyl groups have 4, 5, 6, 7, 8 or 9 carbon atoms, but not that the alkyl groups must always be identical. It is thus possible, for example, for different isomers to be present as the alkyl group.

It is particularly preferable in the context of the present invention that the trialkyl trimellitate in the plasticizer composition according to the invention is one or more compounds selected from the group of tri-n-butyl trimellitate (TBTM), triisopentyl trimellitate (TIPTM), tri-n-pentyl trimellitate (TPTM), tri-2-ethylhexyl trimellitate (TEHTM), triisononyl trimellitate (TINTM) and tri-(n-C8/n-C10) trimellitate (T810TM). Triisopentyl trimellitate in the present case means that the trimellitate is composed of the isomeric C5 alkyl radicals n-pentyl, 2-methylbutyl and 3-methylbutyl. Tripentyl trimellitate preferably contains at least two of the three alkyl groups, e.g. n-pentyl and 2-methylbutyl.

The trialkyl trimellitates according to the invention can be prepared by direct esterification of trimellitic acid (benzene-1,2,4-tricarboxylic acid) or trimellitic anhydride with an alcohol having 4 to 10 carbon atoms, preferably 4 to 9 carbon atoms, further preferably 4, 5, 8 or 9 carbon atoms, more particularly preferably 8 or 9 carbon atoms. The alcohol is preferably used in excess, i.e. in an amount of more than 3 mol per mole of acid component. The direct esterification is also preferably conducted over an acidic catalyst, for example inorganic, organic or Lewis acids.

The trialkyl trimellitate according to the invention can also be prepared via transesterification, by using a trialkyl trimellitate having alkyl groups having fewer than 4 carbon atoms and transesterifying it with an alcohol having 4 to 10 carbon atoms, preferably 4 to 9 carbon atoms, further preferably 4, 5, 8 or 9 carbon atoms, particularly preferably 8 or 9 carbon atoms. Here too, the alcohol carbon atoms can be used in excess.

Preferably, however, the preparation is effected via esterification of trimellitic anhydride with an alcohol having 4 to 10 carbon atoms, preferably 4 to 9 carbon atoms, further preferably 4, 5, 8 or 9 carbon atoms, more preferably 8 or 9 carbon atoms. This forms trialkyl trimellitates, the alkyl groups of which, in accordance with the chain length of the alcohol used, have 4 to 10 carbon atoms, preferably 4 to 9 carbon atoms, preferably 4, 5, 8 or 9 carbon atoms, more preferably 8 or 9 carbon atoms.

The two substances may be present in different amounts in the plasticizer composition according to the invention. It should be clear that the two substances must be present in an amount in which they have an effect, i.e. where a plasticizing effect occurs. In a preferred embodiment of the present invention, the compound of formula (1) and the trialkyl trimellitate are present in the plasticizer composition in a weight ratio (compound of formula (1):trialkyl trimellitate) of 1:99 to 99:1, preferably 10:90 to 90:10, more preferably 30:70 to 70:30. In a very particularly preferred execution of the present invention, the compound of formula (1) and the trialkyl trimellitate are present in the plasticizer composition in a weight ratio (compound of formula (1):trialkyl trimellitate) of 30:70 to 5:95.

The plasticizer composition according to the invention may additionally contain an epoxidized oil or an epoxidized alkyl ester of a fatty acid. Epoxidized oils or corresponding esters can improve thermal stability and mechanical properties.

The epoxidized oil may be selected from the group consisting of epoxidized soybean oil, epoxidized castor oil, epoxidized linseed oil, epoxidized palm oil, epoxidized tall oil and mixtures thereof. Preference is given to using epoxidized soybean oil or epoxidized linseed oil in the plasticizer composition according to the invention. Particular preference is given to epoxidized soybean oil, also known by the acronym ESBO.

The epoxidized fatty acid esters can be prepared by transesterification of the abovementioned epoxidized oils with alcohols in the range of 1 to 10 carbon atoms, preferably 4 to 9 carbon atoms. Alternatively, the natural oil can first be transesterified and the double bonds of the fatty acid can then be epoxidized.

The epoxidized oil or the corresponding epoxidized fatty acid alkyl esters can be used in an amount of 1 to 150 parts by weight based on 100 parts by weight of the sum total of the compound of formula (1) and the trialkyl trimellitate. The epoxidized oil or the epoxidized fatty acid esters may also be present in the plasticizer composition in amounts of 2 to 125 parts by weight, 5 to 100 parts by weight, 10 to 80 parts by weight or 20 to 70 parts by weight, based in each case on 100 parts by weight of the sum total of the compound of formula (1) and the trialkyl trimellitate.

The plasticizer composition according to the invention may additionally comprise at least one further plasticizer selected from the group consisting of adipates, benzoates, for example monobenzoates or glycol dibenzoates, chlorinated hydrocarbons (called chloroparaffins), citrates, epoxidized fatty acid esters, epoxidized vegetable oils, epoxidized acylated glycerides, furandicarboxylates, phosphates, succinates, sulfonamides, sulfonates, terephthalates, isophthalates, phthalates, cyclohexanedicarboxylates, trimellitates excluding those that are part of the plasticizer composition according to the invention, and oligomeric or polymeric esters based on adipic acid, succinic acid or sebacic acid.

In a preferred embodiment of the present invention, the plasticizer composition comprises at least one further plasticizer selected from the group consisting of alkyl benzoates, alkylsulfonic acid esters of phenol, dialkyl adipates, glycerol esters, C4- to C6-alkanoic esters of polyols, trialkyl citrates, acetylated trialkyl citrates, glycol dibenzoates, dialkyl terephthalates, dialkyl phthalates, dialkyl isophthalates, esters of furandicarboxylic acid, dialkanoyl esters of dianhydrohexitols (e.g. isosorbide), epoxidized fatty acid alkyl esters, polymer plasticizers, for example the polyadipates, dialkyl esters of cyclohexane-1,2-,-1,3-or-1,4-dicarboxylic acid, and trialkyl esters of trimellitic acid, except for those that are part of the plasticizer composition according to the invention.

In a further preferred embodiment, at least one further plasticizer that may be present in the plasticizer composition according to the invention is selected from the group consisting of C8- to C13-alkyl benzoates, C4- to C10-dialkyl adipates, pentaerythritol tetravalerate, acetylated trialkyl citrates having C4- to C9-alkyl groups, C4- to C9-dialkyl terephthalates, C4- to C13-dialkyl phthalates, especially C9- to C13-dialkyl phthalates and C4- to C10-dialkyl esters of cyclohexane-1,2-,-1,3-or-1,4-dicarboxylic acid.

Among the citrates, particular preference is given to butyl or pentyl citrates, which may have an acetyl group. These include acetyl tributyl citrate and acetyl tripentyl citrate. Among the C4- to C10-dialkyl adipates, preference is given to diethylhexyl adipate (DEHA) and diisononyl adipate (DINA). Among the C4- to C9-dialkyl terephthalates, preference is given to dibutyl terephthalate (DBT), dipentyl terephthalate (DPT) and diethylhexyl terephthalate (DEHT or DOTP). Among the C4- to C10-dialkyl esters of cyclohexane-1,2-dicarboxylic acid, preference is given to the diethylhexyl cyclohexane-1,2-dicarboxylates (1,2-DEHCH) and the diisononyl cyclohexane-1,2-dicarboxylates (DINCH). Among the C4- to C10-dialkyl esters of cyclohexane-1,4-dicarboxylic acid, preference is given to diethylhexyl cyclohexane-1,4-dicarboxylate (1,4-DEHCH) and diisononyl cyclohexane-1,4-dicarboxylate (DINCD).

The present invention further provides a plastics composition comprising a plastic and the plasticizer composition comprising the compound of the formula (1) and at least one trialkyl trimellitate, where the three alkyl groups each have 4 to 10 carbon atoms, preferably 4 to 9 carbon atoms, further preferably 4, 5, 8 or 9 carbon atoms, more preferably 8 or 9 carbon atoms. The plastics composition may additionally comprise the epoxidized oil and/or an epoxidized fatty acid alkyl ester and/or at least one additional plasticizer from the above list.

Suitable plastics are polymeric substances that are preferably selected from the group consisting of polyvinylchloride (PVC), homo- or copolymers based on ethylene, propylene, butadiene, vinyl acetate, glycidyl acrylate, glycidyl methacrylate, ethyl acrylate, butyl acrylate or methacrylate with alkoxy radicals from branched or unbranched alcohols having one to ten carbon atom(s), acrylonitrile or cyclic olefins, polyvinylidene chloride (PVDC), polyacrylates, in particular polymethylmethacrylate (PMMA), polyalkylmethacrylate (PAMA), polyureas, silylated polymers, fluoropolymers, especially polyvinylidene fluoride (PVDF), polytetrafluoroethylene (PTFE), polyvinylacetate (PVAc), polyvinylalcohol (PVA), polyvinylacetals, especially polyvinylbutyral (PVB), polystyrene polymers, especially polystyrene (PS), expandable polystyrene (EPS), acrylonitrile-styrene-acrylate (ASA), styrene-acrylonitrile (SAN), acrylonitrile-butadiene-styrene (ABS), styrene-maleic anhydride copolymer (SMA), styrene-methacrylic acid copolymer, polyolefins, especially polyethylene (PE) or polypropylene (PP), thermoplastic polyolefins (TPO), polyethylene-vinyl acetate (EVA), polycarbonates, polyethylene terephthalate (PET), polybutylene terephthalate (PBT), polyoxymethylene (POM), polyamide (PA), polyethylene glycol (PEG), polyurethane (PU), thermoplastic polyurethane (TPU), polysulfides (PSu), biopolymers, especially polylactic acid (PLA), polyhydroxybutyral (PHB), polyhydroxyvaleric acid (PHV), polyesters, starch, cellulose and cellulose derivatives, especially nitrocellulose (NC), ethylcellulose (EC), cellulose acetate (CA), cellulose acetate/butyrate (CAB), rubber and silicones.

In a preferred embodiment, the plastic in the plasticizer composition is selected from the group consisting of polyvinylchloride (PVC), polyalkylmethacrylate (PAMA), polyvinylbutyral (PVB), polyurethane, polysulfides, polylactic acid (PLA), polyhydroxybutyral (PHB), nitrocellulose and copolymers of vinyl chloride with vinyl acetate or with butyl acrylate. Among these, particular preference is given to PVC as plastic in the plastics composition according to the invention.

The amount of the plasticizer composition according to the invention in the plastics composition is preferably 5 to 150 parts by weight, preferably 10 to 120 parts by weight, more preferably 15 to 110 parts by weight and most preferably 20 to 100 parts by weight per 100 parts by weight of the plastic.

The plastics composition may contain additional additives as well as the ingredients mentioned. Examples of additional additives are rheological additives with which the viscosity of the plastics composition can be reduced. Examples of known rheological additives are the products available under the trade names VISCOBYK®-5120, VISCOBYK®-5130 and VISCOBYK®-4041. The additives may be present in the plastics composition in a proportion of 1 to 12, preferably 2 to 10, parts by weight per 100 parts by weight of PVC.

In addition, the plastics composition may comprise one or more thermal stabilizer(s). Suitable thermal stabilizers are lead salts, organotin compounds, barium/zinc compounds, cadmium compounds or zinc compounds, calcium/zinc stabilizers and organic-based stabilizers (“OBS”). Preferred thermal stabilizers are barium/zinc compounds, calcium/zinc stabilizers and organic-based stabilizers (“OBS”). The proportion of the stabilizer(s) in the plastics composition is preferably 1 to 4 parts by weight per 100 parts by weight of PVC.

Further additives present in the plastics composition may additionally also be fillers, pigments, blowing agents and lubricants.

The plastics composition according to the invention is preferably part of an adhesive, of a sealing compound, of a coating compound, of a varnish, of a paint, of a plastisol, of a dryblend, of a foam, of an imitation leather, of a floor covering, especially the top layer or foam layer thereof, of a roofing membrane, of an underbody protection, of a fabric coating, of a cable, of a wire insulation, of a hose, of an extruded article, of a film, of an article in the field of automotive interiors, of a wallpaper, of an ink, of a toy, of a contact sheet, of a food packaging or of a medical article, especially of a tube or of a blood bag.

The present invention therefore also provides for the use of the plastics composition in adhesives, sealing compounds, coating compounds, varnishes, paints, plastisols, foams, imitation leathers, floor coverings, especially the top layer and foam layer, roofing membranes, underbody protection, fabric coatings, cables, wire insulation, hoses, extruded articles, films, in the automotive interior sector, in wallpaper, inks, toys, contact sheets, food packaging or medical articles, especially in tubes or blood bags.

The present invention is illustrated hereinafter by examples. The examples which follow are intended to illustrate the invention without restricting its scope of application as apparent from the description and the embodiments.

### EXAMPLES

### Example 1—Preparation of trimethyl cyclohexane-1,2,4-tripropionate (Me-Tc)

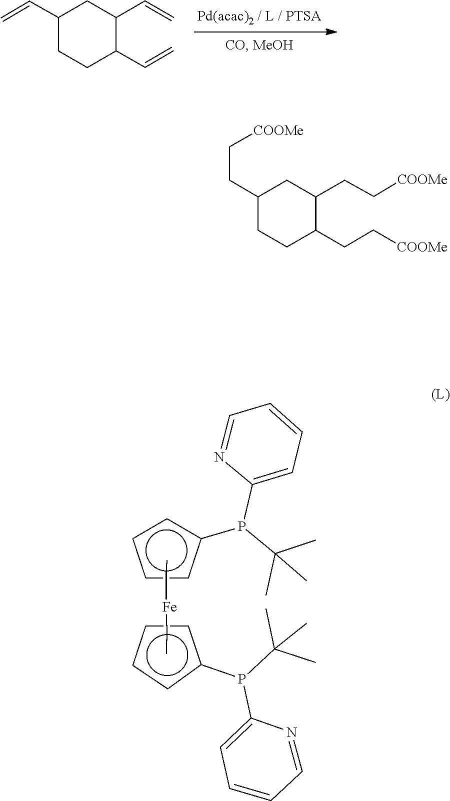

A 100 ml stainless steel autoclave was charged with [Pd (acac) 2] (15.2 mg, 0.1 mol %), the catalyst L (103 mg, 0.4 mol %) and para-toluenesulfonic acid (PTSA, 143 mg, 1.5 mol %) under an argon atmosphere. Then MeOH (30 ml) and trivinylcyclohexane (8.1 g, 50 mmol) were injected by syringe. The autoclave was flushed three times with CO and then CO was injected to a pressure of 40 bar. The reaction was effected at 110° C. for 10 h. Then the autoclave was cooled to room temperature and depressurized. The desired product was purified by distillation (165° C. at 10-3 bar) and characterized by 1H NMR, 13C NMR and HR-MS (15.6 g, 91% yield).

### Example 2—Production of Plastisols

PVC plastisols were produced, as used, for example, for manufacture of topcoat films for floor coverings. The figures in the plastisol recipe are each in parts by weight (phr). The recipe of the polymer composition is listed in Tables 1 and 2.

TABLE 1
Overview of the plastisols produced.

| | 1* | 2* | 3* | 4* |
|---|---|---|---|---|
| Plastisol | phr | phr | phr | phr |
| PVC (Vestolit ® P 1430 K 70 | 100 | 100 | 100 | 100 |
| Ultra; from Vestolit) | | | | |
| Me—Tc (as per Ex. 1) | 16.67 | 25 | 33.33 | 16.67 |
| ELATUR ® TM (triisononyl | 33.33 | 25 | 16.67 | |
| trimellitate, from Evonik Oxeno | | | | |
| GmbH & Co. KG) | | | | |
| Edenol TOT (tri-2-ethylhexyl | | | | 33.33 |
| trimellitate (TOTM), from Emery) | | | | |
| Epoxidized soybean oil as co- | 3 | 3 | 3 | 3 |
| stabilizer (Edenol ® D81, from | | | | |
| Emery) | | | | |
| Thermal stabilizer based on Ca/Zn | 2 | 2 | 2 | 2 |
| (Reagent MBL 197/9 PF) | | | | |

*= composition according to the invention
phr = parts per hundred parts resin

TABLE 2
Overview of the plastisols produced.

| | 5* | 6* | 7 | 8 |
|---|---|---|---|---|
| Plastisol | phr | phr | phr | phr |
| PVC (Vestolit ® P 1430 K 70 | 100 | 100 | 100 | 100 |
| Ultra; from Vestolit) | | | | |
| Me—Tc (as per Ex. 1) | 25 | 33.33 | 0 | 0 |
| ELATUR ® TM (triisononyl | | | 50 | |
| trimellitate, from Evonik Oxeno | | | | |
| GmbH & Co. KG) | | | | |
| Edenol TOT (tri-2-ethylhexyl | 25 | 16.67 | | 50 |
| trimellitate (TOTM), from Emery) | | | | |
| Epoxidized soybean oil as co- | 3 | 3 | 3 | 3 |
| stabilizer (Edenol ® D81, from Emery) | | | | |
| Thermal stabilizer based on Ca/Zn | 2 | 2 | 2 | 2 |
| (Reagent MBL 197/9 PF) | | | | |

*= composition according to the invention
phr = parts per hundred parts resin

First the liquid constituents and then the pulverulent constituents were weighed out into a PE cup. The mixture was stirred manually with a spatula in such a way that there was no longer any unwetted powder. The closed cup was placed in the mount in the Speedmixer and mixed and deaerated. After the mixing was finished, the temperature of the plastisol was measured using an IR thermometer. Then the plastisol was immediately equilibrated to 25.0° C. in a climate-controlled cabinet for further studies.

### Example 3—Gelation Characteristics of the Plastisols

The gelation characteristics of the plastisols from Example 2 were examined by Physica MCR 101 in oscillation mode with a parallel plate analysis system (PP25) operated under shear stress control. An additional heating hood was connected to the system in order to achieve a homogeneous heat distribution and uniform sample temperature.

The following parameters were set:

Mode: Temperature gradient

| | |
|---|---|
| Start temperature: | 25° C. |
| End temperature: | 180° C. |
| Heating/cooling rate: | 5° C./min |
| Oscillation frequency: | 4 to 0.1 Hz logarithmic ramp |
| Cycle frequency omega: | 10 s⁻¹ |
| Number of measurement points: | 63 |
| Measurement point duration: | 0.5 min |
| Automatic gap adjustment F: | 0N |
| Constant measurement point duration | 0.5 mm |
| Gap width | |

### Analysis Procedure

The spatula was used to apply a few grams of the paste to be analysed, without air bubbles, to the lower plate of the analysis system. In so doing, it was ensured that, after the analysis system had been assembled, it was possible for some paste to exude uniformly out of the analysis system (not more than 6 mm in any direction). The excess was removed by spatula. The temperature control hood was subsequently positioned over the sample and the analysis was started. The complex viscosity of the paste was determined after 24 hours (storage of the paste at 25° C. in a temperature control cabinet from Memmert) as a function of temperature.

The parameter considered for gelation was a distinct rise in complex viscosity. The value used for comparison was therefore the temperature on attainment of a paste viscosity of 1000 Pa*s. The results are listed in Table 3.

TABLE 3
Gelation of the plastisols after 24 h, temperature in
° C. on attainment of a paste viscosity of 1000 Pa*s

| | Plasticizer composition according | Gelation |
|---|---|---|
| Recipe | to Tables 1 and 2 | temperature [° C.] |
| 1* | TINTM:Me—Tc 2:1 | 76.5 |
| 2* | TINTM:Me—Tc 1:1 | 70.5 |
| 3* | TINTM:Me—Tc 1:2 | 66.9 |
| 4* | TOTM:Me—Tc 2:1 | 74.1 |
| 5* | TOTM:Me—Tc 1:1 | 69.6 |
| 6* | TOTM:Me—Tc 1:2 | 66.1 |
| 7 | TINTM | 126.9 |
| 8 | TOTM | 112.9 |

*according to the invention

Compared to known trimellitates, the use of trimethyl cyclohexane-1,2,4-tripropionate (Me-Tc) in a plasticizer composition causes a distinct reduction in the gelation temperature. If more Me-Tc is used, the gelation temperature can be lowered further.

### Example 4—Production of Films

The plastisols produced in Example 2 were each processed to give films of thickness 1 mm. For this purpose, first of all, high-gloss release paper (from Sappi, Italy) was trimmed to a size of 30×44 cm and inserted in the clamping frame of the LTSV coating installation for the Mathis oven. The clamping frame was subsequently placed onto the guide frame, the Mathis oven (model LTF) was adjusted to 200° C. and, when this temperature was attained, the frame was preheated for 15 seconds. The coating bar was subsequently inserted into the clamping means and the coating bar gap was adjusted via preliminary experiments such that the film thickness on conclusion of gelation was 1 mm (+/−0.05 mm). An adhesive strip was mounted on the leading edge of the paper in order to catch excess plastisol. The plastisol was then applied in front of the coating knife, and spread by drawing of the guide frame with the coating knife over the clamped released paper (at a speed of 3 m/min). The coating knife was then removed and the adhesive strip with the excess plastisol was removed. The clamping frame was then moved into the oven.

After gelation (2 minutes at 200° C.), the frame was moved back out of the oven and, after cooling, the film was removed from the paper.

### Example 5—Determination of Shore a Hardness

Pieces of 4.8×4.8 cm² were cut out of the films produced according to Example 4. These were stacked in a press frame in 6-8 plies, depending on the film thickness, and pressed at 170° C. and 200 bar. Thereafter, the test specimens were conditioned in a climate-controlled cabinet under standard conditions (25° C., 50% humidity) for at least 16 h and then, in accordance with DIN 48-4, measured with a Shore A measuring instrument from Zwick-Roell. The measured values were read off after 3 seconds. Measurements were conducted at three different sites on each test specimen, and the average was formed. The results are listed in Table 4.

TABLE 4
Shore A hardnesses of the pressed test specimens.

| Recipe | Plasticizer composition according to Tables 1 and 2 | Shore A |
|---|---|---|
| 1* | TINTM:Me—Tc 2:1 | 85 |
| 2* | TINTM:Me—Tc 1:1 | 81 |
| 3* | TINTM:Me—Tc 1:2 | 79 |
| 4* | TOTM:Me—Tc 2:1 | 82 |
| 5* | TOTM:Me—Tc 1:1 | 79 |
| 6* | TOTM:Me—Tc 1:2 | 77 |
| 7 | TINTM | 90 |
| 8 | TOTM | 86 |

The compositions according to the invention show a distinct improvement in plasticizing action and plasticizing efficiency.

1. A plasticizer composition, comprising:
a compound of the formula (1), 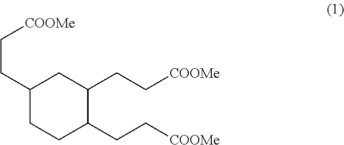 [SMILES: COC(=O)CCC1CCC(CCC(=O)OC)C(CCC(=O)OC)C1]
and
at least one trialkyl trimellitate, where the three alkyl groups each have 4 to 10 carbon atoms.

2. The plasticizer composition according to claim 1, wherein the three alkyl groups are each independently selected from the group consisting of an n-butyl group, an isobutyl group, an n-pentyl group, a 2-methylbutyl group, a 3-methylbutyl group, an n-hexyl group, an isohexyl group, an n-octyl group, a 2-ethylhexyl group, an n-nonyl group, an isononyl group, an n-decyl group, an isodecyl group, and a 2-propylheptyl group.

3. The plasticizer composition according to claim 1, wherein the three alkyl groups have a same number of carbon atoms.

4. The plasticizer composition according to claim 1, wherein the trialkyl trimellitate is tri-n-butyl trimellitate (TBTM), triisopentyl trimellitate (TIPTM), tri-n-pentyl trimellitate (TPTM), tri-2-ethylhexyl trimellitate (TEHTM), triisononyl trimellitate (TINTM) or tri-(n-C8/n-C10) trimellitate (T810TM).

5. The plasticizer composition according to claim 1, wherein the compound of formula (1) and the trialkyl trimellitate are present in the plasticizer composition in a weight ratio (compound of formula (1):trialkyl trimellitate) of 1:99 to 99:1.

6. The plasticizer composition according to claim 1, wherein the plasticizer composition additionally comprises an epoxidized oil or an epoxidized alkyl ester of a fatty acid.

7. The plasticizer composition according to claim 6, wherein the epoxidized oil is selected from the group consisting of epoxidized soybean oil, epoxidized castor oil, epoxidized linseed oil, epoxidized palm oil, epoxidized stearate, epoxidized oleate, epoxidized tall oil, epoxidized linoleate and mixtures thereof.

8. The plasticizer composition according to claim 7, wherein the epoxidized oil is epoxidized soybean oil or epoxidized linseed oil.

9. The plasticizer composition according to claim 6, wherein the epoxidized oil is present in the plasticizer composition in an amount of 1 to 150 parts by weight based on 100 parts by weight of a sum total of the compound of formula (1) and the trialkyl trimellitate.

10. The plasticizer composition according to claim 1, wherein the composition additionally comprises at least one further plasticizer selected from the group consisting of adipates, benzoates, chlorinated hydrocarbons (called chloroparaffins), citrates, cyclohexanedicarboxylates, epoxidized fatty acid esters, epoxidized vegetable oils, epoxidized acylated glycerides, furandicarboxylates, isophthalates, phosphates, succinates, sulfonamides, sulfonates, terephthalates, trimellitates and oligomeric or polymeric esters based on adipic acid, succinic acid or sebacic acid are selected.

11. A plastic composition, comprising:
the plasticizer composition according to claim 1, and
a plastic.

12. The plastic composition according to claim 11, wherein a proportion of the plasticizer composition is 5 to 150 parts by weight per 100 parts by weight of plastic.

13. The plastic composition according to claim 11, wherein the plastic is selected from the group consisting of polyvinylchloride (PVC), polyalkylmethacrylate (PAMA), polyvinylbutyral (PVB), polyurethane, polysulfides, polylactic acid (PLA), polyhydroxybutyral (PHB), nitrocellulose and copolymers of vinyl chloride with vinyl acetate or with butyl acrylate.

14. The plastic composition according to claim 13, wherein the plastic is polyvinylchloride (PVC).

15. A product, comprising:
the plastic composition according to claim 11,
wherein the product is selected from the group consisting of adhesives, sealing compounds, coating compounds, varnishes, paints, plastisols, foams, imitation leathers, floor coverings, roofing membranes, underbody protection, fabric coatings, cables, wire insulation, hoses, extruded articles, films, automotive interior components, wallpaper, inks, toys, contact sheets, food packaging, and medical articles.
